(19) United States
(12) Patent Application Publication
(10) Pub. No.: US 2019/0270482 A1
(43) Pub. Date: Sep. 5, 2019

(54) CONTROL DEVICE FOR POWER STEERING DEVICE

(71) Applicant: HITACHI AUTOMOTIVE SYSTEMS, LTD., Hitachinaka-shi, Ibaraki (JP)

(72) Inventors: Yasuhito NAKAKUKI, Atsugi-shi, Kanagawa (JP); Kazuya YAMANO, Yamato-shi, Kanagawa (JP); Masaki KODATO, Sagamihara-shi, Kanagawa (JP)

(73) Assignee: HITACHI AUTOMOTIVE SYSTEMS, LTD., Hitachinaka-shi, Ibaraki (JP)

(21) Appl. No.: 16/334,732

(22) PCT Filed: Mar. 15, 2017
(86) PCT No.: PCT/JP2017/010444

§ 371 Date: Mar. 19, 2019

(30) Foreign Application Priority Data
Sep. 20, 2016 (JP) 2016-182679

(51) Int. Cl. B62D 6/00; B62D 5/04; G01L 5/22

(52) U.S. Cl. CPC B62D 6/008; B62D 5/0409; B62D 5/0463; B60Y 2400/301; G01L 5/221; B60Y 2400/307; B60Y 2400/303; B62D 5/0481

(57) ABSTRACT

There is provided a control device for a power steering device that provides stable steering feeling in the vicinity of a stroke end. The control device for the power steering device is configured to calculate a stopper torque that is a steering force in a direction opposite to a direction causing a turning angle to approach a stopper angle, based on a steering torque signal, when the turning angle approaches the stopper angle accompanied with a steering operation of a steering wheel, and configured to calculate a motor command signal that is used to drive a power-driven motor, based on a driving condition of a vehicle and the stopper torque.

### TECHNICAL FIELD

The present invention relates to a control device for a power steering device that is configured to assist the steering force of a steering wheel.

### BACKGROUND ART

Conventionally, a technique described in Patent Literature 1 reduces an assist torque toward a mechanical maximum steering position (hereinafter referred to as stroke end) of a power steering device, in order to suppress an impact or the like caused by steering to the stroke end and abruptly stopping the steering.

### CITATION LIST

### Patent Literature

Patent Literature 1: JP 2015-174565A

### SUMMARY OF INVENTION

### Technical Problem

The technique of Patent Literature 1 calculates a control amount of assist torque from a steering angular velocity or a vehicle speed and is thus likely to cause the driver to have strange steering feeling during control. By taking into account this problem, an object of the present invention is to provide a control device for a power steering device that provides stable steering feeling in the vicinity of a stroke end.

### Solution to Problem

A control device for a power steering device according to one aspect of the present invention is configured to calculate a stopper torque that is a steering force in a direction opposite to a direction causing a turning angle to approach a stopper angle, based on a steering torque signal, when the turning angle approaches the stopper angle accompanied with a steering operation of a steering wheel, and to calculate a motor command signal that is used to drive a power-driven motor, based on a driving condition of a vehicle and the stopper torque.

This configuration calculates the stopper torque that suppresses a steering operation causing the turning angle to approach the stopper angle, based on the steering torque that is the torque of the steering operation. This configuration provides an appropriate stopper torque and improves the steering feeling.

### BRIEF DESCRIPTION OF DRAWINGS

FIG. 1 is a schematic system diagram illustrating a power steering device according to Embodiment 1;

FIG. 2 is a control block diagram illustrating the control configuration of the power steering device according to Embodiment 1;

FIG. 3 is a gain map used for stroke end control according to Embodiment 1;

FIG. 4 is a turning state determination map according to Embodiment 1;

FIG. 5 is a flowchart showing a stroke end control process according to Embodiment 1;

FIG. 6 is a flowchart showing a stroke end control process according to Embodiment 2;

FIG. 7 is a flowchart showing a stroke end control process according to Embodiment 3;

FIG. 8 is a gain map used for stroke end control according to Embodiment 3;

FIG. 9 is a flowchart showing a stroke end control process according to Embodiment 4;

FIG. 10 is a characteristic diagram showing a relationship between a target turning angle and limit turning angles according to Embodiment 5;

FIG. 11 is a schematic diagram illustrating a relationship between a traffic lane and an own vehicle according to Embodiment 5;and

FIG. 12 is a flowchart showing rack stroke control according to Embodiment 5.

### DESCRIPTION OF EMBODIMENTS

### Embodiment 1

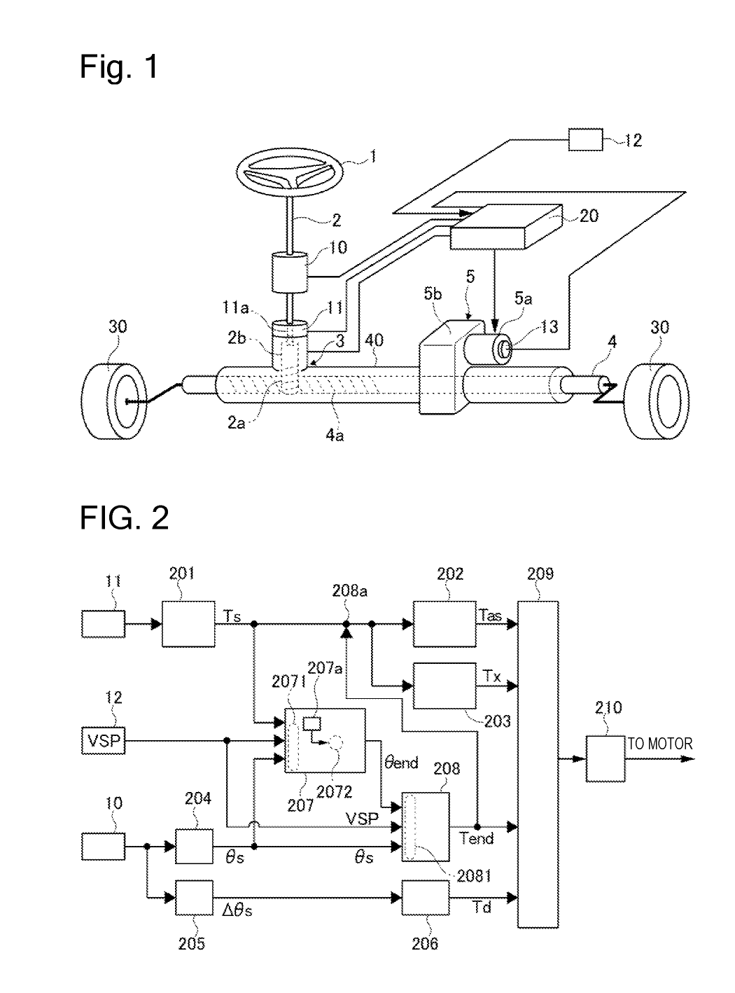

FIG. 1 is a schematic system diagram illustrating a power steering device according to Embodiment 1. A steering shaft 2 is connected to a steering wheel 1. A pinion shaft 2b is connected via a torsion bar 11a to an end of the steering shaft 2 that is on the opposite side to the steering wheel 1. The pinion shaft 2b has a pinion 2a. A rack and pinion mechanism 3 configured such that the pinion 2a meshes with rack teeth 4a is provided in a connecting location where the pinion 2a is connected to a rack placement portion 40 that contains a rack bar 4 therein. This configuration converts rotational motion of the steering wheel 1 into axial motion, and steers turning wheels 30. The rack placement portion 40 is provided with a power steering mechanism 5 that serves to assist the axial force of the rack bar 4. The power steering mechanism 5 includes a power-driven motor 5a and a gear mechanism 5b configured to convert the torque of the power-driven motor 5a into an axial force and apply an assist force to the rack bar 4.

A steering angle sensor 10 is mounted on the steering shaft 2 to detect a steering angle θ that is a driver's steering operation amount of the steering wheel. A torque sensor 11 is provided between the steering shaft 2 and the pinion shaft 2b to detect the driver's steering torque, based on a torsion amount of the torsion bar 11a. The power-driven motor 5a is provided with a motor rotation angle sensor 13 to detect a rotation angle of the power-driven motor 5a. A vehicle speed sensor 12 is also provided to detect a vehicle speed VSP. A control device 20 includes a receiving portion configured to receive signals from the steering angle sensor 10, the torque sensor 11, the vehicle speed sensor 12 and the motor rotation angle sensor 13. The control device 20 controls the electric current of the power-driven motor 5a, based on the various signals, and applies an optimum assist force.

FIG. 2 is a control block diagram illustrating the control configuration of the power steering device according to Embodiment 1. A torque calculating portion 201 calculates the driver's steering torque Ts, based on the detection signal of the torque sensor 11. An assist calculating portion 202 calculates an assist torque Tas as a standard, based on the steering torque Ts, and outputs the calculated assist torque Tas to an adder 209. A phase compensation calculating portion 203 calculates a phase compensation torque Tx that compensates for a phase difference caused by the torsion bar 11a of low rigidity built in the torque sensor 11 and thereby suppresses a vibration of the system, and outputs the calculated phase compensation torque Tx to the adder 209. A turning angle calculating portion 204 calculates a turning angle θs of the turning wheels 30, based on the detection signal of the steering angle sensor 10. A steering speed calculating portion 205 calculates a steering speed Δθs of the steering wheel 1, based on the detection signal of the steering angle sensor 10. A damping torque calculating portion 206 calculates a damping torque Td that gives a viscous resistance to improve the convergence and the stability of the vehicle, based on the steering speed Δθs, and outputs the calculated damping torque Td to the adder 209.

A software rack stopper setting portion 207 includes a signal receiving portion 2071 configured to receive the steering torque Ts, the vehicle speed VSP and the turning angle θs; a stroke end setting portion 207a configured to set a physical stroke end; and a stroke end signal receiving portion 2072 configured to receive the set stroke end. The stroke end setting portion 207a includes a reference value information storage portion configured to store a stroke end reference value θrealend_default that corresponds to the physical stroke end set in advance. The software rack stopper setting portion 207 calculates a right side software rack stopper θRend and a left side software rack stopper θLend that are controlled stroke ends, based on the steering torque Ts, the vehicle speed VSP and the turning angle θs. In the description, the right side software rack stopper θRend and the left side software rack stopper θLend are collectively called software rack stopper θLend. A right side stroke end θRrealend and a left side stroke end θLrealend are collectively called stroke end θrealend.

A stroke end controller 208 calculates a stopper torque Tend, based on the software rack stopper θend, the vehicle speed VSP, the turning angle θs and the steering torque Ts. The stroke end controller 208 outputs the stopper torque Tend to an assist offsetting portion 208a described later and the adder 209. More specifically, the stroke end controller 208 multiplies the steering torque Ts by a gain and outputs a value of an inverted sign as Tend.

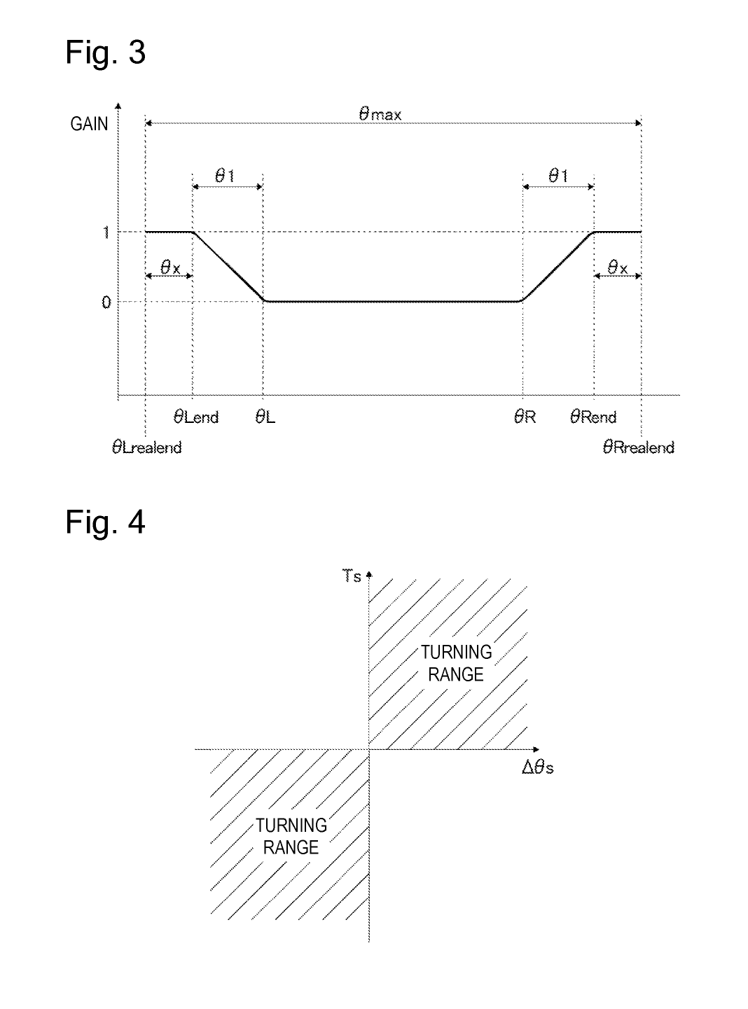

FIG. 3 is a gain map used for stroke end control according to Embodiment 1. The map shows turning angle θ as abscissa and gain as ordinate. A right side software rack stopper θRend that is offset from a right side stroke end θRrealend toward a left side software rack stopper θLend-side by a predetermined deviation angle θx is set on the abscissa. A right side control start value θR that is offset from the right side software rack stopper θend toward the left side software rack stopper θLend-side by a predetermined amount θ1 is also set on the abscissa. Similarly, the left side software rack stopper θLend that is offset from a left side stroke end θLrealend toward the right side software rack stopper θRend-side by the predetermined deviation angle θx is set on the abscissa. A left side control start value θL that is offset from the left side software rack stopper θLend toward the right side software rack stopper θRend-side by the predetermined amount θ1 is also set on the abscissa. In the description below, the right side control start value θR and the left side control start value θL are collectively called control start value θst.

A neutral position of the turning angle θ is located between θL and θR. In this range, the gain is kept at 0 and no control is specifically performed. When the turning angle θ exceeds θR and approaches θRend, on the other hand, the gain is gradually increased toward 1. Similarly, when the turning angle θ exceeds θL and approaches θLend, the gain is gradually increased toward 1. When a large gain is output, the stopper torque Tend is output as a negative value having a large absolute value and decreases a final assist torque. Accordingly, when the gain is equal to 1, a torque cancelling the steering torque Ts is output from the power-driven motor 5a. This reduces the assist torque from the control start position θst toward the software rack stopper θend, while increasing the assist torque from the software rack stopper θend toward the control start position θst to be an ordinary assist torque.

The assist offsetting portion 208a adds the stopper torque Tend. More specifically, on start of stroke end control, the assist offsetting portion 208a multiplies the steering toque Ts by the gain and outputs Tend of the inverted sign. The stopper torque Tend acts to cancel the steering torque Ts. Thus, for example, when the gain is equal to 1, no steering torque Ts is input into the assist calculating portion 202 or to the phase compensation calculating portion 203. Accordingly, neither the assist torque Tas nor the phase compensation torque Tx is output. This prevents an unnecessary assist. On the other hand, the stopper torque Tend is also output to the adder 209. The stopper torque Tend accordingly serves as a torque to cancel a steering torque generated by the driver's muscular power (hereinafter called manual torque Tman). This configuration controls the turning angle θs not to exceed the software rack stopper Send, while suppressing the driver from feeling strange.

A motor torque command calculating portion 210 determines a current value to be commanded to the power-driven motor 5a, based on an assist torque T finally calculated from various torque commands, and outputs the determined current value to the power-driven motor 5a.

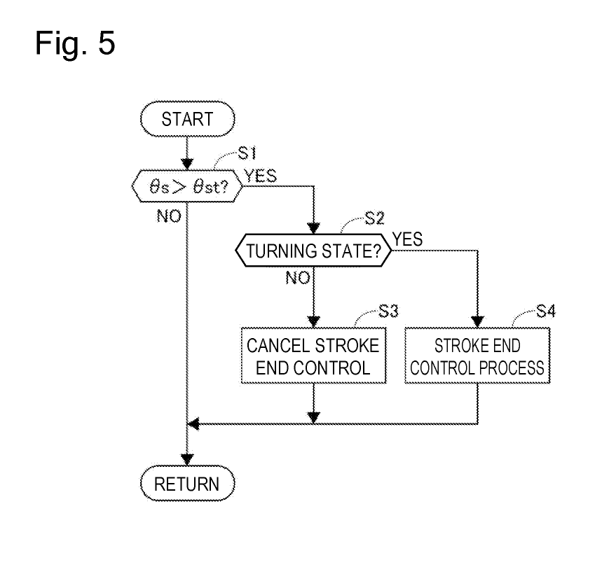

FIG. 5 is a flowchart showing a stroke end control process according to Embodiment 1. At step S1, it is determined whether the turning angle θs exceeds the control start value θst. When the turning angle θs exceeds the control start value θst, the control flow proceeds to step S2. Otherwise, this control flow is terminated. At step S2, it is determined whether the present state is a turning state. When the present state is a turning state, the control flow proceeds to step S4. Otherwise, the control flow proceeds to step S3. FIG. 4 is a turning state determination map according to Embodiment 1. In the map with the steering speed Δθs as abscissa and the steering torque Ts as ordinate, it is determined that the present state is a turning state in a range where both the steering speed Δθs and the steering torque Ts are positive or in a range where both the steering speed Δθs and the steering torque Ts are negative. At step S3, the stroke end control is cancelled. In response to an operation made to separate from the stroke end realend, the ordinary assist control is promptly performed. This prevents the driver from feeling strange. At step S4, the stroke end control process is performed. More specifically, the stroke end control process cancels out the steering torque Ts that is used for calculation of the assist torque or the like and causes the power-driven motor 5a to apply a reactive torque according to the steering torque Ts. This can cancel the manual torque Tman without providing the unnecessary assist torque Tas or the like.

### Advantageous Effects of Embodiment 1

Embodiment 1 has functions and advantageous effects described below.

(1) The control device for the power steering device includes the rack and pinion mechanism 3 (steering mechanism) configured to steer the turning wheels 30 accompanied with a steering operation of the steering wheel 1, and the power-driven motor 5a configured to apply the steering force to the rack and pinion mechanism 3. The control device includes the signal receiving portion 2071 (turning angle signal receiving portion) configured to receive a turning angle signal that is a signal indicating the turning angle θs of the turning wheels 30; the signal receiving portion 2071 (steering torque signal receiving portion) configured to receive a steering torque signal that is a signal indicating the steering torque Ts of the rack and pinion mechanism 3; the software rack stopper setting portion 207 (stopper angle setting portion) configured to set the software rack stopper θend (stopper angle) that is an angle set in a range of the turning angle θs from a stroke end on one side to a stroke end on the other side; the stroke end controller 208 (stopper torque calculating portion) configured to calculate the stopper torque Tend that is a steering force in a direction opposite to a direction causing the turning angle θs to approach the software rack stopper θend when the turning angle θs approaches the software rack stopper θend accompanied with a steering operation of the steering wheel 1, based on the steering torque Ts; and the motor torque command calculating portion 210 (motor command signal calculating portion) configured to calculate a motor command signal that is used to drive the power-driven motor 5a, based on the driving conditions of the vehicle and the stopper torque Tend. This configuration calculates the stopper torque Tend that suppresses a steering operation approaching the software rack stopper θend, based on the steering torque Ts that is a torque of the steering operation, thus providing an appropriate stopper torque Tend and improving the steering feeling. The signal receiving portion 2071 may be configured to directly receive turning angle information from the steering angle sensor 10 or may be configured to estimate the turning angle by calculation from a motor rotation angle signal. The signal receiving portion 2071 may also be a portion of the control device 20 that receives a steering torque signal from the torque sensor 11 or may be a portion provided in the control device 20 that receives a steering torque signal. The software rack stopper setting portion 207 may be configured to set a stopper angle during driving or may be configured as a memory or the like to store a predetermined angle.

(2) The software rack stopper setting portion 207 sets a position offset by a predetermined deviation angle θx from a stroke end θrealend on one side in a direction toward a stroke end on the other side, as a software rack stopper θend on one side, and sets a position offset by a predetermined deviation angle θx from the stroke end θrealend on the other side in a direction toward the stroke end on one side, as a software rack stopper θend on the other side. This applies a steering force to a steering operation in a stroke end direction to suppress the steering operation at a position near to a stroke end and thereby reduces an impact at the stroke end.

(3) The stroke end controller 208 includes a gain correcting portion configured to correct the stopper torque Tend with a gain. The gain is set to increase the stopper torque Tend when the turning angle θs becomes closer to the stroke end θrealend on one side or closer to the stroke end θrealend on the other side. Gradually increasing the stopper torque Tend with approach to the stroke end θrealend reduces the feeling of strangeness caused by steering.

(4) The gain is set to 1 when the turning angle θs is equal to the software rack stopper θend on one side or is equal to the software rack stopper θend on the other side. Accordingly, a turning operation is further performed by applying the stopper torque Tend to be balanced with the steering force when the turning angle θs is equal to the software rack stopper θend. This suppresses an impact from occurring at the stroke end θrealend.

### Embodiment 2

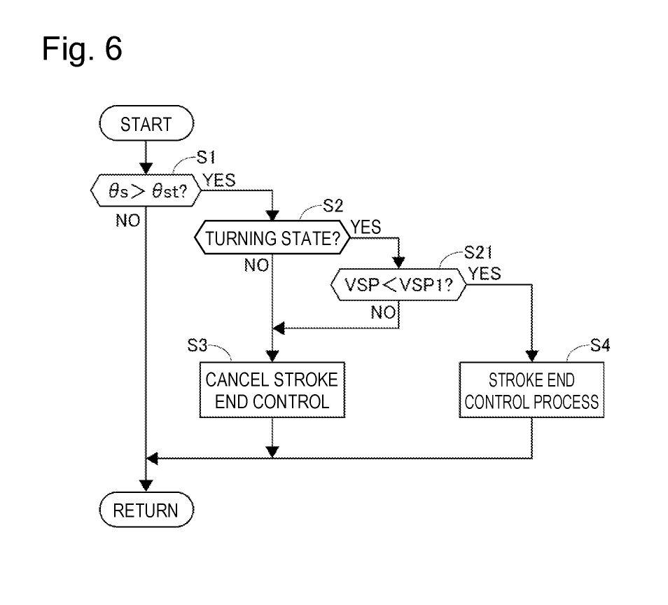

The following describes Embodiment 2. The basic configuration of Embodiment 2 is similar to that of Embodiment 1, and only different points are described. FIG. 6 is a flowchart showing a stroke end control process according to Embodiment 2. In Embodiment 2, at step S21, it is determined whether the vehicle speed VSP is lower than a predetermined vehicle speed VSP1. When the vehicle speed VSP is lower than the predetermined vehicle speed VSP1, the control flow proceeds to step S4 to perform the stroke end control process. When the vehicle speed VSP is equal to or higher than the predetermined vehicle speed VPS1, the control flow proceeds to step S3 to cancel the stroke end control process. The predetermined vehicle speed VPS1 herein denotes a vehicle speed associated with a parking operation at a parking place or the like and is a vehicle speed that does not significantly affect a vehicle behavior even when a steering operation is suppressed. In other words, when the vehicle speed VSP is equal to or higher than the predetermined vehicle speed VPS1, the stroke end control process is not performed based on the stopper torque Tend. When the vehicle speed VPS is equal to or higher than the predetermined vehicle speed VSP1, this prevents the steering operation from being suppressed due to an abnormality of the device, in spite of the turning angle θs that is not close to the stroke end.

### Embodiment 3

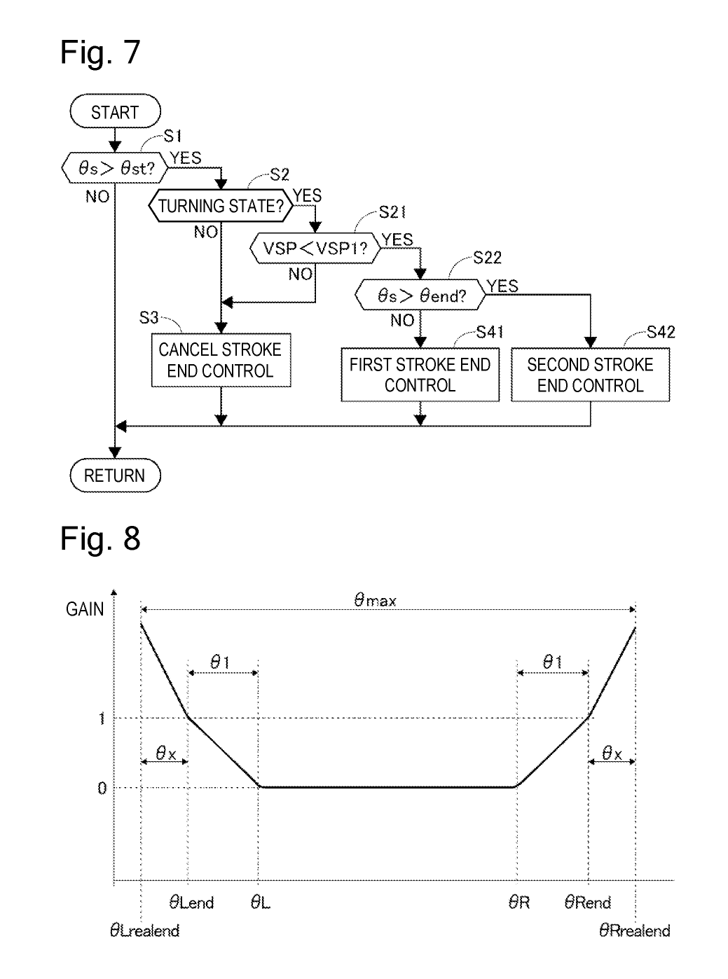

The following describes Embodiment 3. The basic configuration of Embodiment 3 is similar to that of Embodiment 2, and only different points are described. FIG. 7 is a flowchart showing a stroke end control process according to Embodiment 3. In Embodiment 3, at step S22, it is determined whether the turning angle θs is larger than the software rack stopper θend. When the turning angle θs is equal to or smaller than the software rack stopper θend, the control flow proceeds to step S41 to perform a first stroke end control that is similar to the stroke end control performed at step S4 in Embodiment 1 and in Embodiment 2. When the turning angle θs is larger than the software rack stopper θend, on the other hand, the control flow proceeds to step S42 to perform a second stroke end control. FIG. 8 is a gain map used for the stroke end control according to Embodiment 3. In Embodiment 1 and Embodiment 2, when the turning angle θs is larger than the software rack stopper θend, the gain is fixed to 1. The second stroke end control of Embodiment 3, on the other hand, sets a greater slope than the slope of the gain used in the first stroke end control and sets a gain that is larger than 1.

Accordingly, when the driver further turns the steering wheel 1 from the software rack stopper θend toward the stroke end θrealend, a further larger gain is set, and the power-driven motor 5a applies a torque that returns the steering wheel 1 toward the software rack stopper θend.

As described above, Embodiment 3 has functions and advantageous effects described below.

(5) The gain is set to be larger than 1 when the turning angle θs is closer to the stroke end θrealend on one side than the software rack stopper θend on one side or is closer to the stroke end θrealend on the other side than the software rack stopper θend on the other side. This suppresses the occurrence of an impact at the stroke end θrealend. In the state that the turning angle θs reaches the stroke end θrealend, a further turning operation is likely to cause the torque to be beyond the detection range of the torque sensor 11 and to fail to adequately calculate the stopper torque corresponding to a steering torque signal. Setting the gain to be larger than 1 in this state enables an appropriate stopper torque to be applied to an excess steering torque.

(6) When the turning angle θs is closer to the stroke end θrealend on one side than the software rack stopper θend on one side, the gain is set to increase with approach of the turning angle θs to the stroke end θrealend on one side. When the turning angle θs is closer to the stroke end θrealend on the other side than the software rack stopper θend on the other side, the gain is set to increase with approach of the turning angle θs to the stroke end θrealend on the other side. This causes the turning angle θs to be back toward the software rack stopper θend more positively.

### Embodiment 4

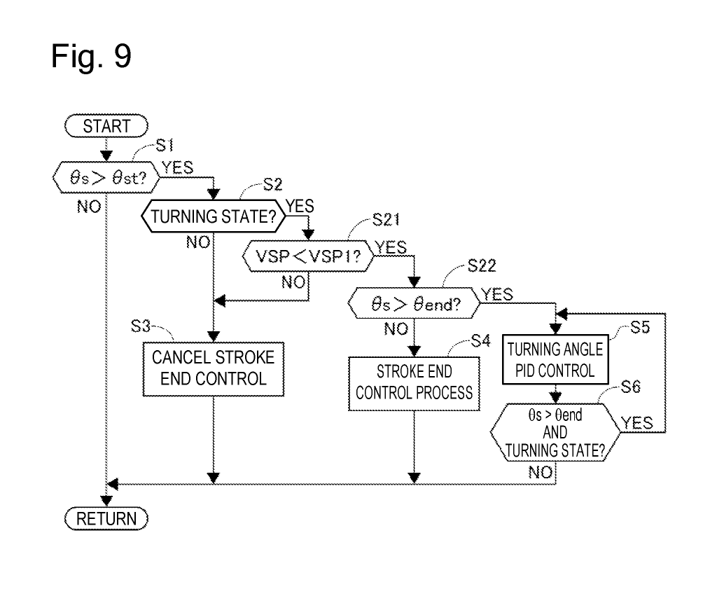

The following describes Embodiment 4. The basic configuration of Embodiment 4 is similar to that of Embodiment 3, and only different points are described. FIG. 9 is a flowchart showing a stroke end control process according to Embodiment 4. According to Embodiment 3, when the turning angle θs is larger than the software rack stopper θend, the gain is set to be larger than 1. According to Embodiment 4, on the other hand, when the turning angle θs is larger than the software rack stopper θend, the software rack stopper θend is set as a target turning angle, and PID control is performed to cause the turning angle θs to become equal to the target turning angle.

At step S5, turning angle PID control is performed. The PID control calculates a stopper torque Tend(pid) according to the following relational expression using a proportional gain Kp, an integral gain Ki, and a derivative gain Kd with regard to a difference Δθbetween the target turning angle and the turning angle θs: Tend(PID)=Kp×Δθ+Ki×(∫Δθdt)+Kd×(d(Δθ)/dt). At step S6, it is determined whether the turning angle θs is larger than the software rack stopper θend and whether the present state is a turning state. When both the conditions are satisfied, the control flow repeats step S5. When either of the conditions is unsatisfied, the control flow cancels stroke end control.

As described above, Embodiment 4 has functions and advantageous effects described below.

(7) When the turning angle θs is closer to the stroke end θrealend on one side than the software rack stopper θend on one side, the stroke end controller 208 calculates the stopper torque Tend such that the power-driven motor 5a generates a torque in a direction back toward the software rack stopper θend on one side. When the turning angle θs is closer to the stroke end θrealend on the other side than the software rack stopper θend on the other side, the stroke end controller 208 calculates the stopper torque Tend such that the power-driven motor 5a generates a torque in a direction back toward the software rack stopper θend on the other side. This causes the turning angle θs to be back toward the software rack stopper θend more positively.

### Embodiment 5

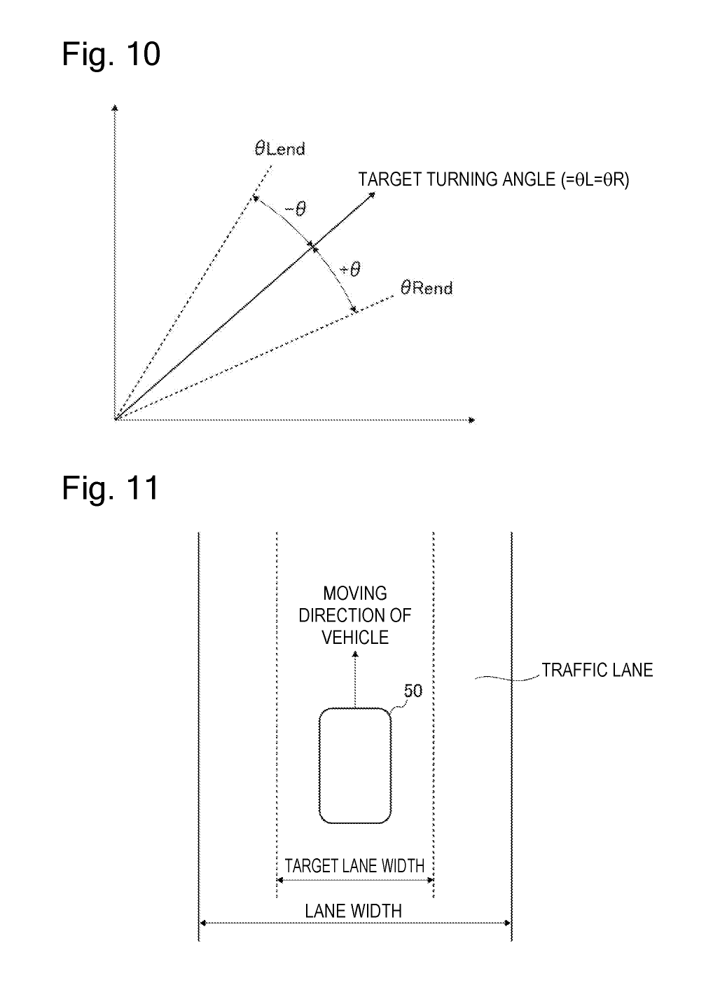

The following describes Embodiment 5. According to Embodiment 4, the target turning angle is set to the software rack stopper θend when stroke end control is applied in the vicinity of the stroke end θrealend. According to Embodiment 5, on the other hand, when the vehicle is driven in a traffic lane, the present invention is applied to LDP control (lane departure prevention control) that causes the vehicle to be driven with being kept in the lane. FIG. 10 is a characteristic diagram showing a relationship between a target turning angle and limit turning angles according to Embodiment 5. FIG. 11 is a schematic diagram illustrating a relationship between a traffic lane and an own vehicle according to Embodiment 5. As shown in FIG. 11, when LDP control is started during a drive in a certain traffic lane, the LDP control sets a target lane width in the width of the lane, calculates a target turning angle such that the vehicle is driven in the target lane width, and controls the turning angle θs to become equal to the target turning angle. More specifically, the target turning angle is set to a turning angle when the vehicle runs through the center of the target lane width along the target lane. In this case, the control start values θst(=θL, θR) on both the left side and the right side are set as the target turning angle. Then, a value calculated by adding a predetermined amount θ to the target turning angle is set as a right side limit turning angle corresponding to the software rack stopper θRend on the right side. A value calculated by subtracting the predetermined amount θ from the target turning angle is set as a left side limit turning angle corresponding to the software rack stopper θLend on the left side. Due to this setting, when the turning angle θs is deviated either leftward or rightward from the target turning angle by the steering torque Ts, a stopper torque Tend is calculated by multiplying the steering torque Ts by a gain, and the turning angle θs is controlled to become equal to the target turning angle. In the description below, this control is called rack stroke control.

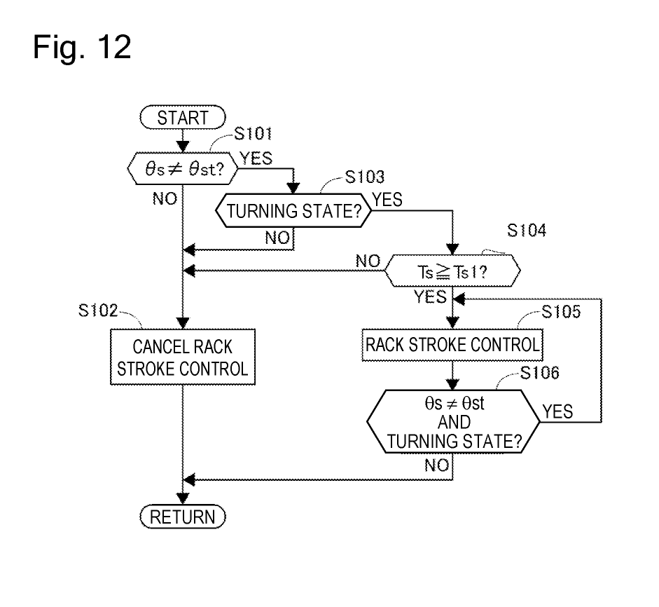

FIG. 12 is a flowchart showing the rack stroke control according to Embodiment 5. At step S101, it is determined whether the turning angle θs is equal to the control start value θst that is the target turning angle. When the turning angle θs is equal to the control start value θst, the control flow proceeds to step S102 to cancel the rack stroke control. When the turning angle θs is not equal to the control start value θst, on the other hand, the control flow proceeds to step S103. At step S103, it is determined whether the present state is a turning state. When the present state is a turning state, the control flow proceeds to step S104. Otherwise, the control flow proceeds to step S102 to cancel the rack stroke control.

At step S104, it is determined whether the steering torque Ts is equal to or higher than a predetermined torque Ts1. When the steering torque Ts is equal to or higher than the predetermined torque Ts1, the control flow proceeds to step S105. When the steering torque Ts is lower than the predetermined torque Ts1, the control flow proceeds to step S102 to cancel the rack stroke control. The predetermined torque Ts1 denotes a case where the driver generates a certain level of the steering torque Ts beyond a range of allowance set in the steering wheel 1. For example, intervention by the LDP control is performed in such a situation that a high torque is unexpectedly entered during a slow steering operation to cause the vehicle to deviate from the traffic lane. At step S105, the rack stroke control is performed. The rack stroke control is a control similar to the stroke end control. The rack stroke control is performed with setting of the target turning angle to θst and setting of the software rack stopper θend to the limit turning angle. When the turning angle θs exceeds the limit turning angle θend, PID control may be performed in place of the gain-based control, to operate the power-driven motor 5a such that the turning angle θs is kept in a range of the limit turning angles θend more positively. At step S106, it is determined whether the turning angle θs is not equal to the target turning angle θst and whether the present state is a turning state. When both the conditions are satisfied, the control flow repeats step S105. When either of the conditions is not satisfied, the rack stroke control is cancelled. This stably controls the turning angle θs along the traffic lane.

Embodiment 4 shows an example that the present invention is applied to the LDP control. The control of the present invention is, however, not limited to the LDP control but may be applied to effectively limit the driver's input of the steering torque Ts in the course of control to the target turning angle in automatic drive control. Embodiment 5 sets the target turning angle to θst. A modification may set the limit turning angle to θst and may cancel out the steering torque Ts by using the gain when the turning angle exceeds the limit turning angle. In a configuration equipped with a brake control device to perform vehicle behavior control and vehicle antiskid control, the present invention may be applied to cancel out the steering torque Ts, in order to avoid an unintentional steering operation caused by the driver's steering error.

The following describes other aspects comprehensible from the embodiments described above. A control device for a power steering device includes a steering mechanism configured to steer a turning wheel accompanied with a steering operation of a steering wheel, and a power-driven motor configured to apply a steering force to the steering mechanism. The control device for the power steering device includes a turning angle signal receiving portion configured to receive a turning angle signal that is a signal indicating a turning angle of the turning wheel; a steering torque signal receiving portion configured to receive a steering torque signal that is a signal indicating a steering torque of the steering mechanism; a stopper angle setting portion configured to set a stopper angle that is an angle set in a range of the turning angle from a stroke end on one side to a stroke end on an opposite side; a stopper torque calculating portion configured to calculate a stopper torque that is a steering force in a direction opposite to a direction causing the turning angle to approach the stopper angle when the turning angle approaches the stopper angle accompanied with a steering operation of the steering wheel, based on the steering torque signal; and a motor command signal calculating portion configured to calculate a motor command signal that is used to drive the power-driven motor, based on a driving condition of a vehicle and the stopper torque. According to one preferable aspect, in the above aspect, the stopper angle setting portion sets a position offset by a predetermined amount from the stroke end on the one side in a direction toward the stroke end on the opposite side, as a stopper angle on the one side, and sets a position offset by a predetermined amount from the stroke end on the opposite side in a direction toward the stroke end on the one side, as a stopper angle on the opposite side. According to another preferable aspect, in any of the above aspects, the stopper torque calculating portion includes a gain correcting portion configured to correct the stopper torque with a gain. The gain is set to increase the stopper torque as the turning angle becomes closer to the stroke end on the one side or closer to the stroke end on the opposite side. According to another preferable aspect, in any of the above aspects, the gain is set to a value 1 when the turning angle is equal to the stopper angle on the one side or equal to the stopper angle on the opposite side. According to another preferable aspect, in any of the above aspects, the gain is set to be larger than the value 1 when the turning angle is closer to the stroke end on the one side than the stopper angle on the one side or is closer to the stroke end on the opposite side than the stopper angle on the opposite side.

According to another preferable aspect, in any of the above aspects, the gain is set to increase with approach of the turning angle to the stroke end on the one side, when the turning angle is closer to the stroke end on the one side than the stopper angle on the one side, and the gain is set to increase with approach of the turning angle to the stroke end on the opposite side, when the turning angle is closer to the stroke end on the opposite side than the stopper angle on the opposite side. According to another preferable aspect, in any of the above aspects, when the turning angle is closer to the stroke end on the one side than the stopper angle on the one side, the stopper torque calculating portion calculates the stopper torque such that the power-driven motor generates a torque in a direction back toward the stopper angle on the one side. When the turning angle is closer to the stroke end on the opposite side than the stopper angle on the opposite side, the stopper torque calculating portion calculates the stopper torque such that the power-driven motor generates a torque in a direction back toward the stopper angle on the opposite side. According to another preferable aspect, in any of the above aspects, the motor command signal calculating portion does not calculate the motor command signal based on the stopper torque, when speed of the vehicle is equal to or higher than a predetermined vehicle speed. According to another preferable aspect, in any of the above aspects, the control device for the power steering device further includes a target turning angle receiving portion configured to receive a signal indicating a target turning angle that is a target angle of the turning angle. The stopper angle setting portion sets the target turning angle as the stopper angle. According to another preferable aspect, in any of the above aspects, the stopper torque calculating portion includes a gain correcting portion configured to correct the stopper torque with a gain. The gain is set to increase the stopper torque with approach of the turning angle to the stopper angle.

The foregoing describes some embodiments of the present invention. Such embodiments of the present invention described above are, however, for the purpose of facilitating the understanding of the present invention and are not intended to limit the present invention. The present invention may be changed, altered and modified without departing from the spirit of the invention and includes equivalents thereof. In the scope of solving at least part of the problems described above or in the scope of achieving at least part of the advantageous effects, any combination or omission of any of the respective components described in the claims and in the specification hereof may be allowed.

The present application claims priority to Japanese patent application No. 2016-182679 filed on Sep. 20, 2016. The entirety of the invention including the specification, the claims, the drawings and the abstract of Japanese patent application No. 2016-182679 filed on Sep. 20, 2016 is hereby incorporated by reference into this application.

### REFERENCE SIGNS LIST

1 steering wheel, 2 steering shaft, 2a pinion, 2b pinion shaft, 3 rack and pinion mechanism, 4 rack bar, 4a rack teeth, 5 power steering mechanism, 5a power-driven motor, 10 steering angle sensor, 11 torque sensor, 11a torsion bar, 12 vehicle speed sensor, 13 motor rotation angle sensor, 20 control device, 30 turning wheel, 40 rack placement portion, 207 software rack stopper setting portion, 207a stroke end setting portion, 208 stroke end controller, 209 adder, 210 motor torque command calculating portion, 2071 signal receiving portion, 2072 stroke end signal receiving portion

1. A control device for a power steering device including a steering mechanism configured to steer a turning wheel accompanied with a steering operation of a steering wheel and a power-driven motor configured to apply a steering force to the steering mechanism, the control device for the power steering device comprising;
a turning angle signal receiving portion configured to receive a turning angle signal that is a signal indicating a turning angle of the turning wheel;
a steering torque signal receiving portion configured to receive a steering torque signal that is a signal indicating a steering torque of the steering mechanism;
a stopper angle setting portion configured to set a stopper angle that is an angle set in a range of the turning angle from a stroke end on one side to a stroke end on an opposite side;
a stopper torque calculating portion configured to calculate a stopper torque that is a steering force in a direction opposite to a direction causing the turning angle to approach the stopper angle when the turning angle approaches the stopper angle accompanied with a steering operation of the steering wheel, based on the steering torque signal; and
a motor command signal calculating portion configured to calculate a motor command signal that is used to drive the power-driven motor, based on a driving condition of a vehicle and the stopper torque.

2. The control device for the power steering device according to claim 1,
wherein the stopper angle setting portion sets a position offset by a predetermined amount from the stroke end on the one side in a direction toward the stroke end on the opposite side, as a stopper angle on the one side, and sets a position offset by a predetermined amount from the stroke end on the opposite side in a direction toward the stroke end on the one side, as a stopper angle on the opposite side.

3. The control device for the power steering device according to claim 2,
wherein the stopper torque calculating portion comprises a gain correcting portion configured to correct the stopper torque with a gain, wherein
the gain is set to increase the stopper torque when the turning angle becomes closer to the stroke end on the one side or closer to the stroke end on the opposite side.

4. The control device for the power steering device according to claim 3,
wherein the gain is set to a value 1 when the turning angle is equal to the stopper angle on the one side or equal to the stopper angle on the opposite side.

5. The control device for the power steering device according to claim 4,
wherein the gain is set to be larger than a value 1 when the turning angle is closer to the stroke end on the one side than the stopper angle on the one side or is closer to the stroke end on the opposite side than the stopper angle on the opposite side.

6. The control device for the power steering device according to claim 5,
wherein the gain is set to increase with approach of the turning angle to the stroke end on the one side, when the turning angle is closer to the stroke end on the one side than the stopper angle on the one side, and
the gain is set to increase with approach of the turning angle to the stroke end on the opposite side, when the turning angle is closer to the stroke end on the opposite side than the stopper angle on the opposite side.

7. The control device for the power steering device according to claim 2,
wherein when the turning angle is closer to the stroke end on the one side than the stopper angle on the one side, the stopper torque calculating portion calculates the stopper torque such that the power-driven motor generates a torque in a direction back toward the stopper angle on the one side, and
when the turning angle is closer to the stroke end on the opposite side than the stopper angle on the opposite side, the stopper torque calculating portion calculates the stopper torque such that the power-driven motor generates a torque in a direction back toward the stopper angle on the opposite side.

8. The control device for the power steering device according to claim 2,
wherein the motor command signal calculating portion does not calculate the motor command signal based on the stopper torque, when speed of the vehicle is equal to or higher than a predetermined vehicle speed.

9. The control device for the power steering device according to claim 1, further comprising:
a target turning angle receiving portion configured to receive a signal indicating a target turning angle that is a target angle of the turning angle, wherein
the stopper angle setting portion sets the target turning angle as the stopper angle.

10. The control device for the power steering device according to claim 9,
wherein the stopper torque calculating portion comprises a gain correcting portion configured to correct the stopper torque with a gain, wherein
the gain is set to increase the stopper torque with approach of the turning angle to the stopper angle.
